(19) United States
(12) Patent Application Publication
(10) Pub. No.: US 2021/0325914 A1
(43) Pub. Date: Oct. 21, 2021

(54) METHOD, ARRANGEMENT AND COMPUTER PROGRAM PRODUCT FOR MONITORING CONSUMABLES OVER A PLURALITY OF USAGE CYCLES

(71) Applicant: SIEMENS AKTIENGESELLSCHAFT, MUENCHEN (DE)

(72) Inventors: DIANA MITSCH, HAMBURG (DE); MICHAEL THIELEMANN, FUERTH (DE)

(21) Appl. No.: 17/253,839

(22) PCT Filed: Jun. 3, 2019
(86) PCT No.: PCT/EP2019/064270

§ 371 Date: Dec. 18, 2020

(30) Foreign Application Priority Data
Jun. 18, 2018 (DE) 10 2018 209 767.4

(51) Int. Cl. G05D 7/06; G05B 15/02

(52) U.S. Cl. CPC G05D 7/06; G05B 15/02

(57) ABSTRACT

A method for monitoring consumables over a plurality of utilization cycles. The method includes providing a consumable with a first unique identifier, detecting the first unique identifier using a mobile terminal, and transmitting the first unique identifier to a central analysis assembly. By the analysis assembly the first unique identifier is linked to additional data regarding the consumable to form a data record. By use of the analysis assembly, the data record for the consumable is managed in such a way that a plurality of utilization cycles of the consumable are detected. The method can be implemented on a corresponding assembly and a computer program product for monitoring consumables over a plurality of utilization cycles.

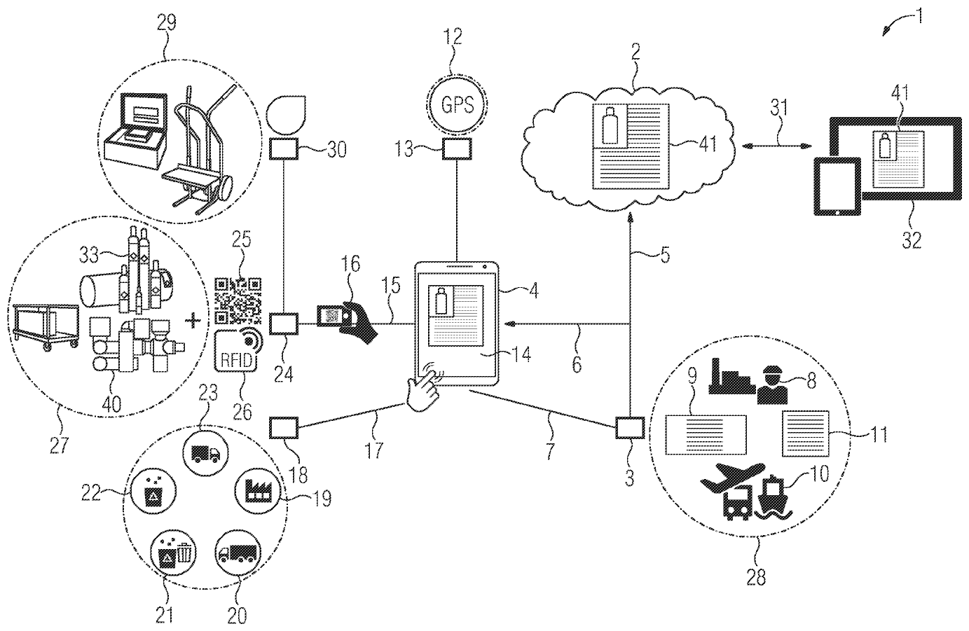

The invention relates to a method according to the preamble of claim 1, to an arrangement according to the preamble of claim 13 and to a computer program product according to claim 18.

To date, it has not been possible to monitor a consumable material such as sulfur hexafluoride (SF6), for example, over a plurality of life cycles or usage cycles. Filled gas cylinders, for example, are bought from the distributer, transported to construction sites and used there to fill gas-insulated switchgear. Subsequently it is then possible only with difficulty to work out which batch of gas having which gas properties was ultimately deposited in the installation and what the approximate state of said batch of gas will be after a certain period of use. In general, the manufacturers have no information about the further use of their gas cylinders or the contents thereof. The stakeholders along the product life cycle of such a gas cylinder or of the SF6 content, such as, for example, transport services, installation manufacturers and waste disposal services, do not have a common system to track a batch. Furthermore, full documentation concerning the use of SF6 as a gas which affects the climate has to be provided to the authorities in accordance with legal requirements in Europe, for example. This is currently possible only with difficulty for many companies involved on account of the incomplete available data.

SF6 cylinders have hitherto been provided with a serial number by the manufacturer, each company involved carrying out their own in-house monitoring of the gas and the gas cylinder.

Furthermore, the publication “MindSphere, The cloud-based, open IoT operating system for digital transformation”, Siemens AG, 2017, identification number 62967-A6 3/17 W discloses the basic principles for cloud-based Platform as a Service (PaaS). The “MindSphere” system described is used, in an automated manner, to load (“Internet of Things”) data from industrial customers (real-time sensor data, for example) into a cloud data memory, to store them there and possibly to link them with further data records. Commercially relevant conclusions are able to be drawn from the linked data by means of data analysis methods. For example, sensor data could be processed together with weather data in order to predict the service life for an industrially used installation and to proactively trigger maintenance so that failures are prevented.

The invention has the object of specifying a method which provides automated, common monitoring for all users of a consumable, wherein a comparatively long period of use or multiple use of the consumable is achieved.

The invention achieves this object by means of a method according to claim 1.

In the context of the invention, a consumable is, for example, a gas which is in a container. A component such as a replacement part, for example, is also a consumable in the context of the invention.

A unique identifier can by way of example be achieved by means of what is known as an RFID tag, which is received using a receiving unit such as a mobile terminal, for example. Visually encoded unique identifiers such as barcodes or Quick Response codes (QR codes) are also suitable identifiers which are for example able to be captured using a camera of a mobile terminal and decoded by the processor of the terminal. In a factory it is possible, for example, for a reading device such as a camera or an RFID reader to be placed at an exit or on a conveyor belt in order to detect a large quantity of consumables (gas containers in transport cages or on pallets) in data records of the evaluation arrangement in an automated manner.

On the part of the manufacturer, a unique identifier in the context of the invention is also able to directly include, for example in addition to a serial number which is linked only in the evaluation arrangement with data transmitted by the manufacturer, the linking data. In this variant, for example, the filling pressure of a gas cylinder and the last date of inspection are additionally noted in the identifier so that this information is provided to subsequent users.

If data communication is not possible for the mobile terminal, scanned unique identifiers and/or additional data are able to be buffer-stored. If data communication is subsequently available, for example via WIFI or LTE, the data are transmitted to the evaluation arrangement.

A mobile terminal is a display means, for example, which has at least intermittently available data communication in order to communicate with a central evaluation arrangement via the Internet, for example. It is possible for a mobile terminal to be a mobile telephone or a tablet, for example. A notebook computer is also suitable.

In the context of the invention, a configuration of the method using a stationary computer may also be understood to be a mobile terminal if for example a user of the consumable manually reads the unique identifier (or takes a photograph) and subsequently feeds this manual reading to the stationary computer. It is also possible for the data records to be output or displayed on a stationary computer, for example in a web browser.

A cloud server of MindSphere described at the outset may for example be used as evaluation arrangement in the context of the invention. Possible additional data are in principle all information that is available to the users of the consumable or by means of automated transmission of sensor measured values in the evaluation arrangement. The data record in the context of the invention is intended to be understood as what is known as a “digital twin” of the consumable, i.e. a central collection of information about an apparatus or consumable, amongst other things.

Here, a usage cycle is, for example, a use of the consumable in a production method or in a product. After the period of use has ended, the consumable would usually be either disposed of or reused. To date, in the case of reuse, no individual-case-specific information about the first usage of the consumable has been available, and, as a result, quality statements are for example able to be made only by way of measurements before renewed use.

The method according to the invention has the advantage that an individual consumable such as, for example, a technically usable gas, is able to be documented in full from manufacture, storage and transport to first and also further usages in technical installations. The final end use and the final destination of the consumable, for example by way of professional recycling or professional disposal, are also able to be documented in full. The documentation is available to all users of the consumable such that information about the degradation or the quality of the consumable may be inferred from the historical data and possibly does not depend, or does not depend exclusively, on measurements.

In a preferred and advantageous embodiment of the method according to the invention, the data record is evaluated by means of the evaluation arrangement in order to determine a quality classification for the consumable, wherein the consumable is used for use in a new usage cycle if it has a minimum quality classification. This is an advantage because a quality of the consumable can be deduced from the available data quickly, simply and inexpensively. A decision criterion as to whether the consumable is able to be recycled is thus provided. This protects the environment and saves costs.

It is possible, for example, to evaluate the data record in such a way that empirical values about the degradation are used. The consumable may be, for example, an electrical insulating gas such as e.g. sulfur hexafluoride (SF6) in a container which is used in gas-insulated switchgear (GIS). If measurement data concerning the temperature and the number of switching operations are linked with the consumable in the evaluation arrangement as additional data, then the data record may be analyzed. By way of example, with knowledge of the number of switching operations and the thermal loading, it could be useful in this example to deduce the degradation that is to be expected for this first usage cycle of the SF6 in this GIS on the basis of empirical values. The degradation of the SF6 is demonstrated, for example, by decomposition products of the inert gas which result when arcs are extinguished.

In a further preferred and advantageous embodiment of the method according to the invention, the data record is managed by means of the evaluation arrangement in such a way that, after the final usage cycle has ended, a final destination and/or professional recycling and/or professional disposal are documented in full. This is an advantage because automated documentation of disposal and recycling means large efficiency gains, which saves time and costs.

In a further preferred and advantageous embodiment of the method according to the invention, a container which is provided with the first unique identifier is used for the consumable. This is an advantage because a gas cylinder comprising a gas is able to be monitored in this way, for example. The data record in the evaluation arrangement accordingly comprises information about the container and data about the gas in the container. If the gas is being used in GIS, additional usage data of the GIS may be added to the data record. If the gas is removed and introduced into another container after the first usage in the GIS has ended, this second container may have a second unique identifier which is added to the data record. In this way, complete documentation of the consumable over a plurality of usage cycles results.

In one development of the embodiment mentioned above, the consumable contains a gas and/or gas mixture which is in the container, wherein on the one hand a plurality of usage cycles of the gas and/or gas mixture, and on the other hand a plurality of usage cycles of the container, are detected by the evaluation arrangement on the basis of the unique identifier. This is a fundamental advantage because, in addition to the gas, the container used is also able to be reused repeatedly and is able to be documented in full in the process.

In one development of the embodiment mentioned above it is determined whether a certain batch of gas from a plurality of different gas cylinders always leads to premature wear on gas-insulated switchgear. A defective batch of this kind is reliably identified and removed from the material cycle. Conversely, it is possible to assign reduced gas shelf lives (if measurements are available) to switchgear or to one type of switchgear if these occur quite frequently.

In a preferred and advantageous embodiment of the method according to the invention, an electrical insulating gas is used as gas in the container. It is possible to use SF6 as insulating gas, for example. A gas mixture may also serve as gas within the context of the invention.

In a preferred and advantageous embodiment of the method according to the invention, an industrial gas is used as gas in the container. Hydrogen, helium or argon, for example, may be used as industrial gas.

In a further preferred and advantageous embodiment of the method according to the invention, a geographical position of the consumable is detected by the mobile terminal and is transmitted to the evaluation arrangement. This can take place, for example, by means of GPS positioning according to the Global Positioning System. The position detection is advantageous because in this way, in particular with the date and time being stored simultaneously, the use of the consumable is historically documented. By way of example, it is then possible to ascertain that a gas cylinder was delivered to a construction site on a certain day and emptied into GIS there.

In a further preferred and advantageous embodiment of the method according to the invention, a radio transmitter is used as unique identifier.

In a further preferred and advantageous embodiment of the method according to the invention, an RFID transmitter is used as radio transmitter.

In a further preferred and advantageous embodiment of the method according to the invention, a visual code is used as unique identifier. It is possible to use a barcode or a QR code, for example.

In a further preferred and advantageous embodiment of the method according to the invention, usage data of an installation for which the consumable is used are used as additional data. The usage data are transmitted from sensors of the installation to the evaluation arrangement, for example. Furthermore, information from logistics software of transport companies may be added as additional data. Information concerning the price of the consumable, orders for the consumable and/or information concerning owners of the consumable may also be added to the data record. Furthermore, documents such as certificates concerning the consumable may also be added to the data record. In addition, documents in analog form such as nameplates, transport documents, gas analysis documents and the like may be added to the data record by way of photos, scanning or manual input of information.

In a further preferred and advantageous embodiment of the method according to the invention, the evaluation arrangement is used to generate a report from the data record in an automated manner, which report satisfies the legal obligations to provide proof pertaining to the use of the consumable.

By way of example, there are extensive registration and information obligations for the use of chemical substances for the manufacturer and other parties in the usage cycle of the substances, which are regulated in “REGULATION (EC) No. 1907/2006 OF THE EUROPEAN PARLIAMENT AND OF THE COUNCIL of Dec. 18, 2006 concerning the Registration, Evaluation, Authorisation and Restriction of Chemicals (REACH), establishing a European Chemicals Agency, amending Directive 1999/45/EC and repealing Council Regulation (EEC) No. 793/93 and Commission Regulation (EC) No. 1488/94 and Council Directive 76/769/EEC and Commission Directives 91/155/EEC, 93/67/EEC, 93/105/EC and 2000/21/EC”. These “REACH” obligations to provide proof comprise reports that document the use and disposal of chemical substances and must be complied with by companies in Europe. The REACH-compliant reports created concerning the consumable are added to the data record after they have been created.

In one development of the abovementioned embodiment of the method according to the invention, information concerning inadvertent and/or unintentional emissions of the consumable is provided in the report. This is achieved by continuous addition of relevant data to the data record and evaluation with regard to unexpected losses, for example an unexpectedly low quantity of gas in comparison with an earlier point in time. An unexpectedly low quantity of gas may be recognized, for example, if a pressure measurement is lower than expected. The data record added to in this way and the detailed information contained therein may be used to directly obtain findings relating to the location, time and relevant process parameters, for example. These findings may be analyzed and resulting conclusions may be drawn about causes of unintentional emissions. Reactive measures may be subsequently initiated in order to put a stop to the inadvertent and/or unintentional emissions of the consumable. For example, a container for a gas may be removed from circulation if there is evidence of leaks. In the case of GIS, maintenance may be triggered upon suspicion of leaks. As a result of these measures, a further inadvertent emission is preventively avoided for the future and a comparatively long period of use or multiple use of the consumable is achieved.

Other obligations to provide proof exist, for example with regard to what is known as the “F-gas Regulation (EU) No. 517/2014”, SESIS (software of Siemens AG). Further obligations to provide proof exist for what are known as dangerous goods (“Dangerous Goods information”). In order to be able to meet the requirements of the international dangerous goods law, it is imperative to classify the gas quality. Requirements pertaining to a pressure and leakage test, to the complete handling and disposal and to the labeling of the products are currently in force.

Otherwise the gas quality often has to be classified as a worst-case scenario (cf. UN 3308). This worst-case scenario then involves a toxic, corrosive dangerous substance. Very strict conditions then apply, therefore, for example for training of staff, obligations to provide proof, back-up plans, etc. The unnecessary “over-classification” may be avoided by way of the invention, which saves considerable outlay and costs.

The invention further has the object of specifying an arrangement which can be used to provide automated, common monitoring for all users of a consumable, wherein a comparatively long period of use or multiple use of the consumable may be achieved.

The invention achieves this object by means of an arrangement according to claim 13. Preferred embodiments are specified in dependent claims 14 to 17. The same advantages as explained initially for the method according to the invention arise analogously for the arrangement according to the invention and its embodiments.

The invention furthermore has the object of specifying a computer program product which, upon execution on a computer, provides automated, common monitoring for all users of a consumable, wherein a comparatively long period of use or multiple use of the consumable is achieved.

The invention achieves this object by means of a computer program product according to claim 18. The same advantages as explained initially for the method according to the invention arise analogously for the computer program product according to the invention.

In order to better explain the invention, a preferred exemplary embodiment is illustrated using a FIGURE.

An arrangement 1 for monitoring consumables 33 over a plurality of usage cycles has an evaluation arrangement 2 which in this example is designed as a cloud application such as Siemens “MindSphere”. The evaluation arrangement 2 is connected to display means 32 by way of data communication 31. The evaluation arrangement 2 is furthermore connected to a mobile terminal 4 by way of data communication 5,6.

The mobile terminal 4 is connected to an information resource 3 for additional data 28 by way of data communication 7. The additional data may be, for example, order information 8, results of gas analyses 9, transport documents 10 and images of nameplates 11 at installations or on gas cylinders. The information resource 3 may be, for example, an external database or a computer of a user of a consumable 33. The mobile terminal 4 may be used to scan or manually input the documents, available in analog form, of the additional data.

The mobile terminal 4 has display means 14 and is in the form of a commercially available smartphone. It has a position detection device 13 for GPS data 12. By way of data communication 17, the mobile terminal 4 is connected to further data resources 18 which, for example, provide information from a plurality of users of the consumable or originate from the computer systems of the users. Information about raw materials 21 that were used for the consumable, transport information 23, manufacturing information 19, delivery information 20 and disposal or recycling information 21 may be included, for example.

The mobile terminal 4 has, for example, a camera in order to read in a Quick Response code (QR code) which is available for consumables 33 or other installations 27 having a unique identifier 25,26. This is possible by means of a scanning operation 16. As an alternative or in addition, a receiving device for RFID signals 26 may be provided.

Furthermore, sensors 29 deliver additional data 30 which may, for example, be captured by means of the mobile terminal and linked with the unique identifier. It is also possible for said data to be transmitted directly to the evaluation arrangement 2.

The operation of the arrangement according to the invention will be discussed below. A gas cylinder 33 containing SF6 is used as consumable in the exemplary embodiment. This gas greatly affects the climate and its use and disposal must be detectable and documented with appropriate accuracy. After manufacture, the SF6 is in a gas cylinder which the manufacturer provides with a unique identifier such as a QR code. The manufacturer transmits data concerning the gas cylinder, such as, for example, the unique identifier, the batch of the gas, the gas pressure, the quality, etc., to the evaluation arrangement in which this information is stored in a data record 41. If the gas cylinder is then transported to a warehouse or a place of use by a transport company 23, the user is able to scan 16 the QR code 25 with the mobile terminal 4. A specific app is provided for this purpose. The QR code 25 is decrypted and transmitted to the evaluation arrangement with GPS location information 12 and a timestamp and added to the data record 41.

At the place of use, for example a manufacturing factory for GIS 40 or a construction site, the QR code 25 of the gas cylinder may be scanned again by the commissioner; position 12, timestamp and unique identifier are added to the data record 41 again. At the place of use the gas cylinder 33 is emptied, for example, and gas is introduced into GIS 40 with the aid of a special service installation and with renewed gas quality information. The empty gas cylinder 33 simultaneously becomes free for reuse.

The empty gas cylinder 33 may, for example, be filled with SF6 of the same quality again. For this purpose, the evaluation arrangement 2 may create a copy of the data record which now incorporates all further information for the new usage cycle of the gas cylinder 33. Documentation spanning usage cycles is ensured as a result. The first unique identifier may continue to be used or a new unique identifier may be attached to the gas cylinder.

The gas introduced into GIS 40 may be removed again after the usage has ended, for example when the GIS 40 is being maintained or disposed of, and may be introduced into another gas cylinder having another unique identifier. Information for the correspondingly present gas quality (SF6 mixture with air or other by-products) of the newly introduced gas is then added to the other unique identifier in the data record. The data record 41 of the gas which is linked with the first unique identifier is additionally stored with the new unique identifier of the new gas cylinder, the position of the gas cylinder and with a timestamp. It is possible in this way to trace the use of the gas, even in a new life cycle, back to the manufacture. The evaluation arrangement 2 is therefore designed to manage the data record 41 concerning the consumable 33 in such a way that a plurality of usage cycles of the consumable 33 are detected.

The evaluation arrangement 2 is designed to evaluate the data record 41 in order to determine a quality classification for the consumable 33, wherein the consumable 33 may be used for use in a new usage cycle if it has a minimum quality classification. In this example, from the number of switching operations and the thermal loading of the GIS 40, the degradation that is to be expected for this first usage cycle of the SF6 in this GIS 40 is deduced on the basis of empirical values. The degradation of the SF6 is demonstrated, for example, by decomposition products of the inert gas which result when arcs are extinguished. The degradation correlates with the minimum quality classification here such that the threshold for the minimum quality is not reached when there is severe degradation of the gas. In such a case the gas will not be reused.

It is of particular economic value for the evaluation arrangement 2 to be used to generate a report from the data record 41 in an automated manner, which report satisfies the legal obligations to provide proof, such as, for example, EU F-gas or ZVEI (German Electrical and Electronic Manufacturers' Association) reports, pertaining to the use of the consumable SF6. The appropriate reports may be made available to all involved users 19,20,21,22,23 of the consumable 33 via the app on the mobile terminal 4. In the context of the invention, the app and the appropriate reports may, however, also be viewed on stationary computers, that is to say for example on desktop computers of the involved users 19,20,21,22,23 of the consumable 33. In such a case the app may be designed as a hybrid app, for example, which on the one hand enables display on a mobile terminal and on the other hand enables display on a non-mobile desktop computer, for example in the browser.

It is therefore possible for every user to retrieve complete documentation at any time.

1-18. (canceled)

19. A method for monitoring consumables over a plurality of usage cycles, which comprises the steps of:
providing a consumable with a first unique identifier;
capturing the first unique identifier using a mobile terminal;
transmitting the first unique identifier to a central evaluation system; and
linking the first unique identifier with additional data relating to the consumable to form a data record by means of the central evaluation system, the data record concerning the consumable is managed by means of the central evaluation system in such a way that the plurality of usage cycles of the consumable are detected.

20. The method according to claim 19, which further comprises evaluating the data record by means of the central evaluation system in order to determine a quality classification for the consumable, wherein the consumable is used for use in a new usage cycle if it has a minimum quality classification.

21. The method according to claim 19, which further comprises managing the data record by means of the central evaluation system in such a way that, after a final usage cycle has ended, a final destination and/or professional recycling and/or professional disposal are documented in full.

22. The method according to claim 19, wherein a container which is provided with the first unique identifier is used for storing the consumable.

23. The method according to claim 22, wherein the consumable contains a gas and/or gas mixture which is in the container, wherein the plurality of usage cycles of the gas and/or gas mixture, and the plurality of usage cycles of the container, are detected by the central evaluation system on a basis of the first unique identifier.

24. The method according to claim 19, which further comprises detecting a geographical position of the consumable by the mobile terminal and transmitting the geographical position to the central evaluation system.

25. The method according to claim 19, wherein the first unique identifier is a radio transmitter.

26. The method according to claim 25, which further comprises using a radio-frequency identification transmitter as the radio transmitter.

27. The method according to claim 19, which further comprises using a visual code as the first unique identifier.

28. The method according to claim 19, wherein usage data of an installation for which the consumable is used are used as the additional data.

29. The method according to claim 19, which further comprises using the central evaluation system to generate a report from the data record in an automated manner, wherein the report satisfies legal obligations to provide proof pertaining to a use of the consumable.

30. The method according to claim 29, wherein information concerning inadvertent and/or unintentional emissions of the consumable is provided in the report.

31. A configuration for monitoring consumables over a plurality of usage cycles, the configuration comprising:
a mobile terminal; and
an evaluation system configured to receive a first unique identifier of a consumable from said mobile terminal, and to link the first unique identifier with additional data regarding the consumable to form a data record, said evaluation system further configured to manage the data record concerning the consumable in such a way that a plurality of usage cycles of the consumable are detected.

32. The configuration according to claim 31, said evaluation system is configured to evaluate the data record in order to determine a quality classification for the consumable, wherein the consumable may be used for use in a new usage cycle if it has a minimum quality classification.

33. The configuration according to claim 31, wherein said evaluation system is configured to generate a report from the data record in an automated manner, wherein the report satisfies legal obligations to provide proof pertaining to use of the consumable.

34. The configuration according to claim 31, wherein said mobile terminal is configured to capture the first unique identifier and to transmit it to said evaluation system.

35. The configuration according to claim 34, wherein the consumable is stored in a container which is provided with the first unique identifier.

36. A non-transitory computer readable medium storing computer executable instructions which upon execution in a computer, carry out a method for monitoring consumables over a plurality of usage cycles, which comprises the steps of:
providing a consumable with a first unique identifier;
capturing the first unique identifier using a mobile terminal;
transmitting the first unique identifier to a central evaluation system; and
linking the first unique identifier with additional data relating to the consumable to form a data record by means of the central evaluation system, the data record concerning the consumable is managed by means of the central evaluation system in such a way that the plurality of usage cycles of the consumable are detected.
